(19) United States
(12) Patent Application Publication
(10) Pub. No.: US 2013/0123003 A1
(43) Pub. Date: May 16, 2013

(54) AUTOMATIC DETECTION OF DEVIANT PLAYERS IN MASSIVELY MULTIPLAYER ONLINE ROLE PLAYING GAMES (MMOGS)

(71) Applicants: Dmitri Williams, Redondo Beach, CA (US); Muhammad Aurangzeb Ahmad, Minneapolis, MN (US); Jaideep Srivastava, Plymouth, MN (US); Brian Keegan, Cambridge, MA (US); Noshir Contractor, Evanston, IL (US)

(72) Inventors: Dmitri Williams, Redondo Beach, CA (US); Muhammad Aurangzeb Ahmad, Minneapolis, MN (US); Jaideep Srivastava, Plymouth, MN (US); Brian Keegan, Cambridge, MA (US); Noshir Contractor, Evanston, IL (US)

(73) Assignees: University of Southern California, Los Angeles, CA (US); Northwestern University, Evanston, IL (US); Regents of the University of Minnesota, Minneapolis, MN (US)

(21) Appl. No.: 13/401,541

(22) Filed: Feb. 21, 2012

Related U.S. Application Data
(60) Provisional application No. 61/445,366, filed on Feb. 22, 2011.

(51) Int. Cl. G07F 17/32

(52) U.S. Cl. CPC G07F 17/3241
USPC 463/29

(57) ABSTRACT

Gold farming refers to the illicit practice of gathering and selling virtual goods in online games for real money. Although around one million gold farmers engage in gold farming related activities, to date a systematic study of identifying gold farmers has not been done. Here data is used from the Massively Multiplayer Online Role Playing Game (MMOG) EverQuest II to identify gold farmers. This is posed as a binary classification problem and a set of features is identified for classification purposes. Given the cost associated with investigating gold farmers, criteria are also given for evaluating gold farming detection techniques, and suggestions provided for future testing and evaluation techniques.

### CROSS-REFERENCE TO RELATED APPLICATIONS

This application is based upon and claims priority to U.S. provisional patent application No. 61/445,366, entitled “Automatic Gold Farmer Detection in Online Games,” filed Feb. 22, 2011, attorney docket number 028080-0624, the entire content of which is incorporated herein by reference.

### STATEMENT REGARDING FEDERALLY SPONSORED RESEARCH

This invention was made with government support under Grant No. IIS-0729505, awarded by the National Science Foundation, and Grant No. W91WAW-08-C-0106, awarded by the Army Research Institute. The government has certain rights in the invention.

### BACKGROUND

1. Technical Field

This disclosure relates to the detection of prohibited gold farming in massively multiplayer role playing games (MMOGs).

As information communication technologies have grown more pervasive in social and cultural life, deviant and criminal uses have attracted increasing attention from scholars [16], [13]. Virtual communities in massively-multiplayer online games (MMOGs) such as World of Warcraft and EverQuest II have millions of players engaging in cooperative teams, trade, and communication. These games primarily operate on a monthly subscription basis and have over 45 million subscriptions among Western countries alone, and perhaps double that number in Asia [32]. While the in-game economies exhibit characteristics observed in real-world economies [6], a grey market of illicit transactions also exists. Virtual goods like in-game currency, scarce commodities, and powerful weapons require substantial investments of time to accumulate, but these can also be obtained from other players within the game through trade and exchange.

Gold farming or real-money trading refers to a body of practices that involve the sale of virtual in-game resources for real-world money. The name gold farming stems from a variety of repetitive practices (“farming”) to accumulate virtual wealth (“gold”) which farmers illicitly sell to other players who lack the time or desire to accumulate their own in-game capital. By repeatedly killing non-player characters (NPCs) and looting the currency they carry, farmers accumulate currency, experience, or other forms of virtual capital which they exchange with other players for real money via transactions outside of the game. Gold buyers then employ the purchased virtual resource to obtain more powerful weapons, armor, and abilities for their avatars, accelerating them to higher levels, and allowing them to explore and confront more interesting and challenging enemies [4].

Game developers do not view gold farmers benignly and have actively cracked down on the practice by banning farmers' accounts [30], [3]. In-game economies are designed with activities and products that serve as sinks to remove money from circulation and prevent inflation. Farmers and gold buyers inject money into the system disrupting the economic equilibrium and creating inflationary pressures within the game economy. In addition, farmers' activities often exclude other players from shared game environments, employing computer subprograms to automate the farming process, and engaging in theft of account and financial information [21]. Game companies are also motivated to ban farmers to ensure that the game fulfills its role as a meritocratic fantasy space apart from the real world [28]. Because gold farmers are motivated only to accumulate wealth by the repetitive killing of NPCs, they detract from other players game experience and may drive legitimate players away [26].

While the earliest instances of real money trade can be traced back to the terminal-based multi-user dungeons (MUDs) of the 1970s and 80s [18], formal gold farming operations originated in an early massively multiplayer online role-playing game, Ultima Online, in 1997. An informal cottage industry of inconsequential scale and scope at first, the practice grew rapidly with the parallel development of an e-commerce infrastructure in the late 1990s [11], [12]. The complexity of gold trading organizations continued to grow as indigenously-developed massively multiplayer games as well as Western-developed games were released into East Asian markets like Japan, South Korea, and China [7], [17]. Gold farming operations now appear to be concentrated in China where the combination of high-speed internet penetration and low labor costs has facilitated the development of the trade [12], [2], [10]. The scale of real money trading has been estimated to be no less than $100 million and upwards of $1 billion annually [12], [5], [25], and the phenomenon has begun to capture popular attention [2], [27].

2. Description of Related Art

Previous studies of virtual property have focused on the economic impacts [5] user rights and governance [21], [14], and legal vagaries [1], [19] rather than the behaviors of the farmers themselves. Surveys of players have measured the extent to which the purchase of farmed gold occurs and how players perceive both producers and consumers of farmed gold [36], [35]. Other research has imputed the scale of the activity based upon proxy measures of price level stabilization and price similarity across agents [24], [25]. No fieldwork beyond journalistic interviews has been done in this domain because of a confluence of factors. Secrecy is highly valued, given the prevalence of competitors as well as the negative repercussions of being discovered [23], [20]. The popular perception of gold farming as an abstract novelty, the rapid pace of innovation and adaptation in organizations and technology, the significant language barriers, and the geographic distance likewise conspire against thorough observation or systematic examination [15]. Yet perhaps the largest barrier has been the lack of availability of data from the game makers themselves. If the data were present, data mining and machine learning techniques exist to explore the phenomenon. These have received considerable attention in the context of detecting and combating cybercrime [29], [9]. Other studies employing social network analysis, entity detection, and anomaly detection techniques have been used extensively in this context [22], [8]. The current research is the first to take advantage of these techniques by virtue of cooperation with a major game developer, Sony Online Entertainment. As outlined below, the current research is the first scholarly attempt to employ data mining and machine learning to detect and identify gold farmers in a data corpus drawn from a live MMOG.

### SUMMARY

A system for automatically identifying gold farmers in a massively multiplayer role playing game (MMOG) comprising: an input module configured to receive data containing information about players in the MMOG; an analysis module configured to analyze the data for the purpose of identifying players that appear likely to be gold farmers; and a reporting module configured to report the results of the analysis.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 shows Precision vs. Recall for Demographic Features.

FIG. 2 illustrates ROC for Demographic Features.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

Game Mechanics

The study uses anonymized data archived from the massively-multiplayer online game Everquest II. In this fantasy role-playing world, a user controls a character to interact with other players in the game world as well as non-player characters (NPCs) controlled by the code of the software. Users complete quests, slay NPCs, and explore new areas of the game to earn experience points as well as currency that allows them to purchase more powerful equipment. The experience required to advance one additional level increases exponentially and more powerful weapons, armor, and spells likewise become more expensive and difficult to acquire at higher levels. Players can shortcut to more exciting content by purchasing the requisite weapons, armor, and skills rather than engaging in the more tedious aspects of accumulating the resources to sell or exchange for these items. Because players can exchanges goods and currency within the game, being able to obtain a large reserve of game currency from another character reduces the time investment necessary to progress.

Gold Farming

As previously discussed, gold farmers repeatedly kill in-game NPCs and collect the currency they carry. The tedious nature of this activity is somewhat lessened by the use of automated programs called bots which simulate user input to the game. While the size of the market for virtual “gold” has created intense competition within the gold farming industry, the ability for the game company to ban these accounts and effectively destroy the value they have accumulated likewise introduces a substantial amount of uncertainty into farmers' operations. These operators have adapted to the environment by employing a highly-specialized value chain that both minimizes the amount of effort and time required to procure gold as well as reducing the likelihood of being detected and attendant issues of losing inventory. Discussions with game administrators have revealed that accounts engaged in gold farming operations within the game fulfill five possible archetypes [33]:
Gatherers: Accounts accumulating gold or other resources.
Bankers: Distributed, low-activity accounts that hold some gold in reserve in the event that any one gatherer or other banker is banned.
Mules and Dealers: One-time characters that interact with the customer, act as a chain to distance the customer from the operation, and complicate administrator back-tracing.
Marketers: One-time accounts that are “barkers,” “peddlers,” or “spammers” of the company's services.

The roles are not necessarily exclusive nor proscriptive, but these descriptions of behavioral signatures will inform subsequent methods. The highly specialized roles of gold farmers also suggests that they differ from typical players along several potential salient and latent dimensions. Where players are largely motivated to explore the game and storyline as they gain experience and level up, gold farmers may follow highly optimized paths that allow them to level quickly without engaging in these sideshows. Currently gold farmers are caught in a number of ways such as heuristic-based methods which would indicate illegitimate activity in the game, reporting of gold farmers by other players, peculiar behavior of players like making a large number of transactions over a very short span of time, and “sting” operations. In all the above cases after being potentially flagged as a gold farmer the activities of the player in the past, present and the future have to be analyzed by a human expert before it can be ascertained that the player is indeed a gold farmer and not a legitimate player. These administrators are the ultimate arbiters of which users are banned.

### Data Description

Anonymized EverQuest II database dumps were collected from Sony Online Entertainment. Five distinct types of data were extracted for analysis: experience logs, transaction logs, character attributes, demographic attributes, and cancelled accounts.
Demographic information of player: Demographic information about the player in the real-world. This is already anonymized so that it is not possible to link the player back to a real-world person.
Character game statistics of players: These characteristics are of two types. “Demographic” characteristics of the character like race (human, orc, elf etc), character sex, etc.; Cumulative statistics like total number of experience points earned, or number of monsters killed.
Anonymized player-player social interaction information: This information is available in the form of messages sent from one player to another over a given period of time. It should be noted that the content of the messages themselves was not recorded.
Player activity sequence: Players can perform a wide range of activities within the game. The sequences of activities include but are not limited to mentoring other players, leveling up, killing monsters, completing a recipe for a potion, fighting other players, etc.
Player-Player economic information: This information is in the form of number of items sold or traded by one player to another player.

The canceled accounts contained dates, account IDs, and rationales for an administrator canceling an account including abusive language, credit card fraud, and gold farming. These players were either caught by the game developer's staff or were identified for investigation by other players. Players and developers recognize that is by no means a comprehensive list, and some unknown gold farmers elude capture. However, our starting point was a simple list of those who were captured. The rationales were manually parsed to identify cases with rationales pertaining to gold farming and real money trade and extracted to generate a master list of accounts banned for gold farming. There were a total of 2,122,600 unique characters out of which 9,179 were gold farmers, or 0.43% of the population.

Character attributes are the stored attributes of every character at their most recent log-out such as level, experience, class type, damage resistance, and so forth. The player demographic table included self-reported characteristics such as player birthday, account creation date, country, state, ZIP code, language, and gender. The popular stereotype of gold farmers being Chinese men appears to be borne out in the descriptive analysis as 77.6% of players banned for gold farming speak Chinese while only 16.8% of users speaking Chinese have been banned for farming. In the game, women make up 13.5% of the population, the average player is 31.6 years old, the average account is 3.7 years old, and the most commonly spoken languages are English (80%), German (2.4%), Chinese (2.08%), French (1.57%), and Swedish (1.29%). The experience and transaction tables are longitudinal records of every event in the game that awards experience points to a player or results in an item being exchanged between players, respectively. Given the large size of these datasets, the analysis was limited to the month of June 2006 and contains 24,328,017 records related to experience and 10,085,943 records related to user transactions. Out of the 23,444 players with behavioral data for June 2006, only 147 were subsequently identified as gold farmers.

### Methods

One of the most important tasks in data mining and machine learning is selecting the features to be used in the classifier. This approach uses data mining and machine learning to identify gold farmers by using an analysis in two phases. The first phase is a deductive logistic multiple regression model that describes the characteristics of gold farmers that differentiate them from a random sample of the population. The second phase is inductive and evaluates a cross-section of well-known binary classifiers like Naive-Bayes, KNN, Bayesian Networks, Decision Trees (J48) to correctly identify gold farmers. We propose to study the problem of identifying gold farming as a binary classification problem. One of the motivations for doing so was that class labels for gold farmers were readily available. It should be noted that the two methods are complementary to each other, the inductive method can be used to describe characteristics that can differentiate gold farmers from non-gold farmers. The data mining based method can be used to make predictions about particular players if they are gold farmers or not.

Phase I: Deductive Logit Model

Because a single account can potentially control several characters, the master list of banned characters was collapsed by character level to generate a list of the highest-level character on 12,134 banned accounts. The banned table was joined with the character and demographic attribute tables by account number. A random sample of non-banned accounts matched by sever population was added as a control. The total sample was 24,267 unique account-characters. Based upon previous accounts of the behavior of gold farmers, we identified sets of demographic and character attributes to use as independent variables and controls in the sequential logistic regression against the binary banned/not-banned outcome.
Player demographics (Model 1): Player demographics (Model 1): Players banned for gold farming should be younger, more male, speak more Chinese, and have more recently-established accounts than typical players.
Salient gold farming behavioral characteristics (Model 2): Players banned for gold farming should play for more extended periods of time, have more recorded adventuring time, a greater number of NPC kills, and greater overall wealth than typical players.
Non-salient gold farming behavioral characteristics (Model 3): Players banned for gold farming should have lower levels of quests completed, active quests, tradeskill knowledge, tradeskill manufacturing, and deaths than typical players.
Model 4 integrates the explanatory variables of models 2 and 3 to analyze identified behavioral characteristics and model 5 integrates model 1 and model 4 to control and analyze for both demographic and behavioral variables. The complete model (5) has a very good fit to the observed data (r²=0.677) and logistic regression diagnostics indicate no substantial multicollinearity or specification errors. With respect to other behavioral characteristics, the large standardized coefficients for character age, number of NPCs killed, number of deaths, and experience gained from completing quests suggest these be employed for classification.

Phase II: Inductive Machine Learning Models

Each set of features can be used separately to build classifiers or alternatively different types of features can be combined in the same classifier. We identify 22 unique types of activities in the data that form the basis of regular expression alphabets for analysis. It should be noted that some of these activities could also be divided into many sub-activities e.g., one activity that we identify is killing a monster, which can be divided in terms of killing a monster of level 5 versus killing a monster of level 10 since the nature of the encounter in both cases is significantly different.

After identifying and extracting the features, the main intuition behind posing this problem as a classification problem is that gold farmers possess certain demographic and behavioral characteristics that can be exploited. For the features about the distribution of activities, we extracted Activity Sequence Features which are the number of times the player was engaged in that activity e.g., the number of monsters killed, the number of potion recipes completed, number of times the player was killed, etc. In addition to the features that were available to us directly from the dataset we constructed another set of features based on the sequences of activities performed by the players.

The behavioral data of any given player can be captured by looking into the sequence of activities performed by a player in a given session. A session is defined as a chunk of time in which the player was continuously playing the game e.g., if a player played the game for two hours in the morning and one hour in the evening on the same day then the game play for that day is said to constitute two different sessions of game. In order to reconstruct session we look at the ordered lists of all the activities in terms and a set of k activities is said to belong to the same session if the time difference between any two adjacent activities is less than 30 minutes. Thus consider the following example of a sequence in a session: KKKDdKdEKdKD where K is killed a monster, D is player died, d is damage points and E is points earned. This sequence implies that the player killed three monsters before being killed, after resurrection the player suffered some damage followed by killing the monster but sustained further damage, and so on.

The experiments were performed on the open source Data Mining software Weka which has implementations of many well-known data mining algorithms [34]. Results from different sets of features are given in a series of tables below. Since the current problem is a rare class problem we only report the classification results for the rare class as the precision and recall for the dominant class is more than 99% in almost all the cases. It would have been helpful if there was a baseline model for comparing the result of these classification models, however catching gold farmers is currently a time-consuming manual process.

In the series of tables listed in this section various measures of performance are given, but the most relevant to choose a classifier is precision vs. recall. From the domain experts point of view the goal of any gold farmer-detecting technique should be to increase the number of true positives (correctly identified gold farmers) while at the same time decreasing the number of false positives (legitimate players labeled as gold farmers). It is essential for these classifications to have high precision to minimize the number of false positive since any positive match has to be investigated by an administrator. Recall captures the other aspect of performance i.e., capturing as many gold farmers as possible but requires the actual number of positives in the dataset. While the records in the data are all labeled as gold farmers and are assumed to certain gold farmers, there are likely to be players in the dataset who are gold farmers but were not identified or banned.

TABLE 1
STANDARDIZED BETA COEFFICIENTS; T STATISTICS IN PARENTHESES
*P < .05, **P < .01, ***P < .001, N = 24267

| Variable | Model 1 | Model 2 | Model 3 | Model 4 | Model 5 |
|---|---|---|---|---|---|
| Player age | 0.097* (−2.54) | | | | −0.174*** (−3.78) |
| Account age | −1.713*** (−25.81) | | | | −0.747*** (−10.83) |
| Chinese | 4.410*** (−64.06) | | | | 3.846*** (−48.23) |
| Female | 0.028 (−0.65) | | | | −0.102 (−1.95) |
| Character age | | 1.481*** (−17.69) | | 3.585*** (−28.46) | 3.405*** (−23.39) |
| Time adventuring | | 3.031*** (−53.69) | | 1.326*** (−20.17) | 0.553*** (−7.01) |
| NPC kills | | −1.792*** (−24.22) | | −3.011*** (−20.67) | −3.759*** (−20.89) |
| Bank wealth | | −0.175*** (−5.36) | | −0.025 (−0.50) | −0.008 (−0.13) |
| Personal wealth | | 0.095** (−2.89) | | 0.488*** (−9.57) | 0.763*** (−12.73) |
| Rare items collected | | −0.615*** (−16.98) | | 0.882*** (−12.88) | 0.868*** (−9.3) |
| Quests completed | | | −5.375*** (−54.71) | −5.352*** (−45.52) | −3.045*** (−20.72) |
| Quests active | | | −0.566*** (−6.62) | −0.424*** (−4.59) | −0.162 (−1.37) |
| Recipes known | | | −1.337*** (−15.46) | −1.366*** (−14.83) | −0.752*** (−6.31) |
| Items crafted | | | 1.454*** (−19.27) | 0.312*** (−3.87) | 0.267** (−2.65) |
| Total deaths | | | 6.644*** (−69.92) | 4.983*** (−34.74) | 3.359*** (−19.14) |
| Total PVP deaths | | | −0.289*** (−6.31) | −0.318*** (−5.94) | −0.447*** (−6.14) |
| Psuedo-R² | 0.550 | 0.214 | 0.430 | 0.530 | 0.677 |

TABLE II
Feature Space for Various Types of Features

| Feature Type | Features |
|---|---|
| Demographic | Gender, Language, Country, State |
| Character Stats | Character Race, Character Gender, Character Class, |
| | Accumulated Experience, Platinum, Gold, Silver, |
| | Copper, Guild Rank, Character age, Total Deaths, City |
| | Alignment, PVP Deaths, PVP Kills, PVP Title Rank, |
| | Achievement Experience, Achievement Points. |
| Economic | Number of Transactions as Seller, Number of |
| Features | Transactions as Buyer |
| Anonymized | Indegree, Outdegree |
| Social Interaction | |

### Results

Phase I: Deductive Logit Model

The analysis from Phase I demonstrated that non-salient behavioral characteristics (model 3) accounted for substantially more variance than the salient behavioral characteristics (model 2). This suggests that along these salient characteristics (wealth, time played, rare items acquired), gold farmers may not differ substantially from other (elite) players but are significantly different along more latent characteristics such as how many quests they complete, how often they die, and their tradeskill expertise. It is likewise telling that even with 12 distinct predictive variables of gold farming activity in model 4, the 4-variable demographic-only model (model 1) still accounted for more of the variance among players identified as gold farmers. The analysis also bears out the intuition that players with old and well-established accounts are not as likely to be gold farmers.

Other than Chinese language (a dummy variable), player demographic attributes have a small effect compared to other variables. High levels of NPC kills, quests completed, and tradeskill recipe knowledge all strongly decreased the likelihood of being identified as a gold farmer in the model. This combination of variables suggests that farmers exhibit low levels of expertise across a variety of metrics. High levels of time played, time spent adventuring, and high total deaths are all factors associated with gold farming activity which also implies a low level of expertise within the game itself. While the accumulation of wealth in a bank was not significantly associated with gold farming activity which suggests that farmers have possibly adapted their behavior on this count to avoid detection the model does predict that gold farmers carry more coins on their character.

Phase II: Inductive Machine Learning Models

Using only the players self-reported demographic characteristics for classification should have strongly predicted the identification of gold farmers given their skewed language distribution, but as seen in Model 1, two classifiers (JRIP and J48) misclassified every instance of the “farmer” class. By F-score, the KNN algorithm is the best metric for demographic features. Examining only features of the character played within the game, model 2 reveals that the algorithms identify gold farmers with much lower precision and recall than the demographic model alone. The findings for activity distribution in model 3 are marginally better than the previous model employing character features classifiers but the KNN algorithm has markedly inferior precision and recall as compared to the demographic model. These predictive machine learning findings corroborate our earlier descriptive regression results that the salient behavioral characteristics on which we expect gold farmers to be differentiated from other players (wealth, time played, etc.) are not reliable features. The inability to distinguish farmers suggests that they are able to cloak their behavior given their similarity to highly-skilled players along the variables included in these models.

TABLE III
DESCRIPTION OF MODELS

| Model name | Classifier features |
|---|---|
| Model 1 | Demographic features only |
| Model 2 | Character features only |
| Model 3 | Activity distribution features |
| Model 4 | Demographic and accumulation features |
| Model 5 | Sequence activity features |
| Model 6 | Activity distribution features |
| | and economic transactions |
| Model 7 | Activity distribution features |
| | for gold farmer sub-class |

TABLE IV
CLASSIFIER PERFORMANCE FOR ALL GOLD FARMERS (BY MODEL)

| Classifier | Measure | Model 1 | Model 2 | Model 3 | Model 4 | Model 5 | Model 6 | Model 7 |
|---|---|---|---|---|---|---|---|---|
| BayesNet | Prec. | 0.208 | 0.033 | .0125 | 0.291 | .131 | 0.134 | 0.109 |
| | Recall | 0.225 | 0.186 | 0.102 | 0.513 | 0.131 | 0.102 | 0.265 |
| | F-Score | 0.216 | 0.057 | 0.112 | 0.371 | 0.131 | 0.116 | 0.155 |
| NaiveBayes | Prec. | 0.211 | 0.051 | 0.042 | 0.204 | 0.052 | 0.037 | 0.038 |
| | Recall | 0.223 | 0.136 | 0.19 | 0.223 | 0.293 | 0.19 | 0.313 |
| | F-Score | 0.216 | 0.074 | 0.069 | 0.213 | 0.088 | 0.061 | 0.068 |
| LogisticReg. | Prec. | 0.636 | 0.182 | 0.333 | 0.630 | 0.091 | 0.300 | 0.273 |
| | Recall | 0.192 | 0.017 | 0.020 | 0.192 | 0.010 | 0.020 | 0.036 |
| | F-Score | 0.294 | 0.031 | 0.038 | 0.294 | 0.018 | 0.038 | 0.064 |
| AdaBoost | Prec. | 0.412 | 0.051 | 0.042 | 0.271 | 0.052 | 0.037 | 0.038 |
| | Recall | 0.138 | 0.136 | 0.190 | 0.183 | 0.293 | 0.190 | 0.313 |
| | F-Score | 0.207 | 0.074 | 0.069 | 0.218 | 0.088 | 0.061 | 0.068 |
| J48 | Prec. | 0 | 0.75 | 0.286 | 0 | 0.143 | 0.353 | 0.300 |
| | Recall | 0 | 0.025 | 0.027 | 0 | 0.010 | 0.041 | 0.036 |
| | F-Score | 0 | 0.049 | 0.050 | 0 | 0.019 | 0.073 | 0.065 |
| JRIP | Prec. | 0 | 0.333 | 0.286 | 0.526 | 0.250 | 0 | 0.250 |
| | Recall | 0 | 0.068 | 0.014 | 0.056 | 0.020 | 0 | 0.060 |
| | F-Score | 0 | 0.113 | 0.026 | 0.102 | 0.037 | 0 | 0.097 |
| KNN | Prec. | 0.493 | 0.050 | 0.086 | 0.345 | 0.112 | 0.122 | 0.176 |
| | Recall | 0.304 | 0.017 | 0.061 | 0.361 | 0.111 | 0.082 | 0.157 |
| | F-Score | 0.376 | 0.025 | 0.071 | 0.353 | 0.112 | 0.098 | 0.166 |

Next, we incorporated both the previous demographic features with cumulative statistics of how much experience and money characters had. As shown in Table V, the performance of all algorithms increased substantially across the board with the BayesNet exhibiting the strongest recall performance and KNN being an accurate predictor of gold farming activity. We next used our alphabet of 22 activities captured in the experience and transaction logs to perform two analyses incorporating activity sequences alone and the distribution of activity with economic transactions. We define a set of 10 patterns in Table VI to measure whether the sequences of activities were predictive. As seen in Table VII, this sequence approach alone has poor precision and recall across all algorithms compared to previous methods. Table VIII describes the results for activity distribution as well as character and demographic features. The low discriminatory power of this sequence method implies that, again, farmers and non-farmers do not differ substantially along the sequences we have specified.

TABLE V
SEQUENCE PATTERNS FOR PLAYER ACTIVITIES

| Sequence | Explanation |
|---|---|
| KKKKKKKKKK+ | 10 or more kills in a row |
| d+K+ | One or more damage followed by one or more |
| | kills |
| d+[a-z,A-Z]*K+ | Damage followed by other activities |
| | and then by one or more kills |
| E+[a-z,A-Z]*K+ | Pattern 4: Earned payment followed |
| | by other activities and then by one or more kills |
| M+S+ | One or more mentoring instances followed by |
| | successful completion of recipes |
| M+[a-z,A-Z]*K+ | Damage followed by other activities |
| | and then by kills |
| K+D | One or more kills followed by the death of the |
| | character |
| E+D | One or more earned payments followed by the |
| | death of the character |
| M+[a-z,A-Z]*q | Mentoring followed by other activities and |
| | then by quest points |
| M+[a-z,A-Z]*K+ | Mentoring followed by other activities |
| | and then by one or more kills |
| M+E+ | One or more instances of mentoring followed |
| | by one or more instances of earned payments |
| MMMMMMMMMM+ | Ten mentoring instances in a row |

TABLE VI
CLASSIFIER PERFORMANCE FOR ALL GOLD FARMERS
(ACTIVITY DISTRIBUTION FEATURES)

| Classifier | TPR | FPR | Prec. | Recall | F-Score | ROC |
|---|---|---|---|---|---|---|
| BayesNet | 0.102 | 0.005 | 0.125 | 0.102 | 0.112 | 0.797 |
| NaiveBayes | 0.19 | 0.027 | 0.042 | 0.19 | 0.069 | 0.632 |
| Logistic Reg. | 0.02 | 0 | 0.333 | 0.02 | 0.038 | 0.661 |
| AdaBoost | 0.19 | 0.027 | 0.042 | 0.19 | 0.069 | 0.629 |
| J48 | 0.027 | 0 | 0.286 | 0.027 | 0.05 | 0.535 |
| JRIP | 0.014 | 0 | 0.286 | 0.014 | 0.026 | 0.512 |
| KNN | 0.061 | 0.004 | 0.086 | 0.061 | 0.071 | 0.529 |

TABLE VII
CLASSIFIER PERFORMANCE FOR ALL GOLD FARMERS
(ACTIVITY DISTRIBUTION FEATURES & ECONOMIC
TRANSACTIONS)

| Classifier | TPR | FPR | Prec. | Recall | F-Score | ROC |
|---|---|---|---|---|---|---|
| BayesNet | 0.102 | 0.004 | 0.134 | 0.102 | 0.116 | 0.812 |
| NaiveBayes | 0.19 | 0.032 | 0.037 | 0.19 | 0.061 | 0.628 |
| Logistic Reg. | 0.02 | 0 | 0.3 | 0.02 | 0.038 | 0.685 |
| AdaBoost | 0.19 | 0.032 | 0.037 | 0.19 | 0.061 | 0.628 |
| J48 | 0.041 | 0 | 0.353 | 0.041 | 0.073 | 0.523 |
| JRIP | 0 | 0 | 0 | 0 | 0 | 0.502 |
| KNN | 0.082 | 0.004 | 0.122 | 0.082 | 0.098 | 0.539 |

TABLE VIII
CLASSIFIER PERFORMANCE GOLD FARMER SUB-CLASS
(ACTIVITY DISTRIBUTION FEATURES)

| Classifier | TPR | FPR | Prec. | Recall | F-Score | ROC |
|---|---|---|---|---|---|---|
| BayesNet | 0.265 | 0.008 | 0.109 | 0.265 | 0.155 | 0.644 |
| NaiveBayes | 0.313 | 0.028 | 0.038 | 0.313 | 0.068 | 0.724 |
| Logistic Reg. | 0.036 | 0 | 0.273 | 0.036 | 0.064 | 0.697 |
| AdaBoost | 0.313 | 0.028 | 0.038 | 0.313 | 0.068 | 0.69 |
| J48 | 0.036 | 0 | 0.3 | 0.036 | 0.065 | 0.596 |
| JRIP | 0.06 | 0.001 | 0.25 | 0.06 | 0.097 | 0.519 |
| KNN | 0.157 | 0.003 | 0.176 | 0.157 | 0.166 | 0.577 |

TABLE IX
F-MEASURES FOR ALL GOLD FARMERS
(DEMOGRAPHIC & STATISTICS FEATURES)

| Classifier | F₁-Score | F_{0.8}-Score | F₂-Score | F_{0.5}-Score |
|---|---|---|---|---|
| BayesNet | 0.371 | 0.350 | 0.445 | 0.318 |
| NaiveBayes | 0.213 | 0.211 | 0.218 | 0.207 |
| Logistic Reg. | 0.294 | 0.333 | 0.223 | 0.432 |
| AdaBoost | 0.218 | 0.228 | 0.195 | 0.247 |
| J48 | 0 | 0 | 0 | 0 |
| JRIP | 0.102 | 0.123 | 0.068 | 0.196 |
| KNN | 0.353 | 0.351 | 0.357 | 0.348 |

A close analysis of gold farmers indicate that the number of tasks performed by the gold farmers vary greatly. This can potentially be the source of confusion for the classifiers when instances of the same class exhibit a wide range of characteristics and thus are not discriminatory enough. To address this issue we removed all such instances from the dataset. When we removed all instances where the number of activities associated with gold farmers was less than six, the number of gold farmers was reduced to 83. We then reran the same set of classifier for this new dataset for the activity distribution features, the results of which are given in table IX. It should be noted that the performance of most of the classifiers improves in terms of both precision and recall. This confirms our earlier hypothesis that the various subclasses within the gold farmer class could be a source of confusion for the classifiers.

### Classifier Selection

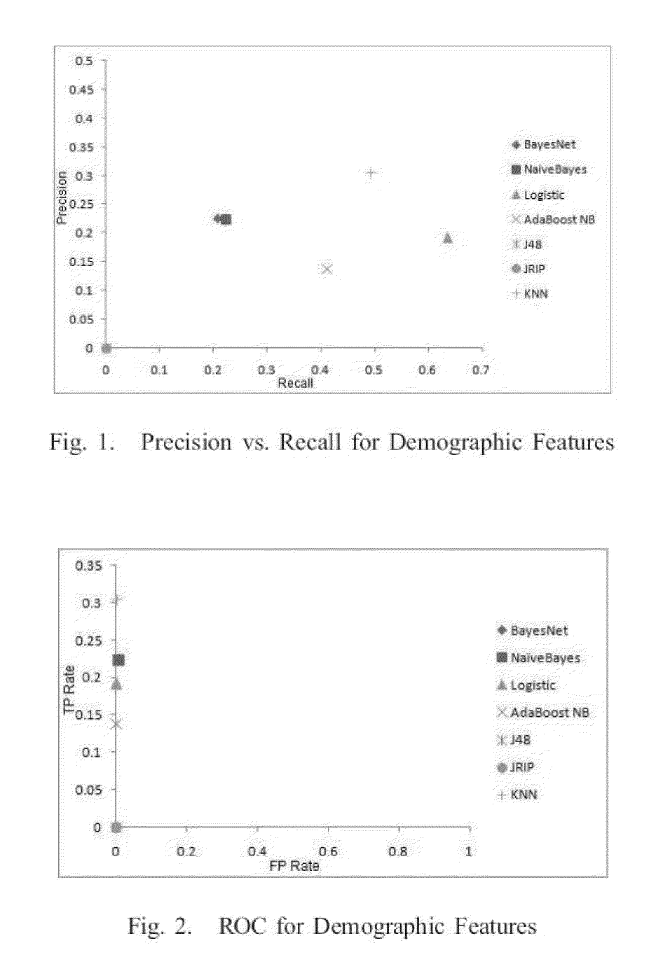

Given that the range of values for precision and recall are observed for the various classifiers that we described, we would suggest a classifier that consistently outperformed all other classifiers in terms of precision and recall. However this is not the case as trade-offs between precision and recall are to be expected. The best F-Score was obtained by using demographic features with KNN, yet BayesNet gives the highest value for recall if both the demographic and the character statistics are used. This can be further illustrated by the precision vs. recall graph for the demographic features as illustrated in FIG. 2; while KNN has the best precision, logistic regression has better recall. An alternative would be to use the ROC curve to decide which classifier to use. However, this cannot be used in our case since the false positive rate is extremely low for all the cases of classifiers and features that we have investigated. This can be illustrated by FIG. 1 where all the data points are aligned almost to the y-axis. Using information about the relative proportion of false positives and true positives is not available in this case. However, we can address the problem of selecting a consistent classifier by referring to the domain. As described previously, there are two main constraints that we are trying to satisfy: increasing the number of gold farmers who are caught by an algorithm and reducing the number of false positives as this would translate into work that has to be done by humans. Thus, given scarce human resources, precision should be given a high priority. One the other hand, if enough human resources are available, then more false positives can be tolerated if the number of true positives are likely to increase. This tradeoff can be captured by using the generalized version of van Rijsbergens [31] F-measure as the metric for decision making. It can be described as follows:

F_{β}=(1+β²)·(precision·recall)/(β²·precision+recall)

where β is a scaling factor that describes the relative importance of recall with respect to precision. This criteria can be illustrated as follows. If equal weight is given to both precision and recall then Bayes not should be used as the classifier of choice. The same would occur if recall is given twice as importance as precision. However if precision is given twice as importance as recall then Logistic Regression will be chosen, similarly if recall is said to be only 80% as important as precision then KNN would be chosen. The choice of values for β would depend upon the domain expert while taking into account the resources available.

### CONCLUSION

Using an anonymized dataset extracted from the massively multiplayer online game EverQuest II, we used several machine learning binary classification techniques to identify gold farmers within the game world. A number of feature types were explored for classification and various combinations of classifiers and features gave a wide range of results in terms of precision and recall. Despite the strong, significant effects observed across five logistic regression models for exploratory analysis, classifier algorithms operating on seven different combinations of behavioral data were not able to precisely identify gold farmers. We attribute the difficulty in discriminating between gold farmers and legitimate players to farmers specialization into distinct roles that exhibit very different behavioral signatures. From a domain expertise point of view, given the trade-off between identifying gold farmers and amount of effort required in investigating we proposed that the generalized F-Measure should be used to select which context. We note, however, that our evaluation is likely to be conservative. Since we cannot know the true number and identity of gold farmers within the data, it is possible—perhaps likely—that a number of our false positives were farmers who had yet to be caught. Thus the precision rates here should be seen as a minimum baseline. If these cases could be investigated more closely, some may translate into true positives, further validating the approach. Our future work will explore how to incorporate the behavioral signatures of each distinct gold farming role. These behavioral signatures will inform the development of different hierarchical regression models as well as building different classifiers. Here we have simply looked at the overall performance of the classifiers in detecting gold farmers. It could be the case that some classifiers are much better in classifying certain types of gold farmers. Future research should also seek to develop a more systematic approach to determine sequences of patterns of activities that can be used to identify gold farmers as well as longitudinal analyses of how these behavioral signatures change over time. Given the applicability of this line of research to identifying other forms of cybercrime such as credit card fraud and money laundering as well as national security applications, we anticipate that the methods we develop for detecting gold farming could potentially be applied to these other datasets for validation.

### REFERENCES

All articles, patents, patent applications, and other publications that have been cited in this disclosure are incorporated herein by reference. All references listed below are incorporated herein by reference.
[1] J. Balkin, Virtual Liberty: Freedom to Design and Freedom to Play in Virtual Worlds, Virginia Law Review, vol. 90, no. 8, 2004.
[2] D. Barboza, Ogre to Slay? Outsource It to Chinese, Book Ogre to Slay? Outsource It to Chinese, Series Ogre to Slay? Outsource It to Chinese, ed., Editor ed. eds., 2005, pp.
[3] T. Bramwell, World of Warcraft players banned for selling gold, Book World of Warcraft players banned for selling gold, Series World of Warcraft players banned for selling gold, 2005.
[4] Castronova, E. (2005). Synthetic worlds: The business and culture of online games. Chicago: University of Chicago Press.
[5] Castronova, E. (2006) A cost-benefit analysis of real-money trade in the products of synthetic economies, Info, 8(6), 51-68
[6] Castronova, T., D. Williams, C. Shen, Y. Huang, B. Keegan, L. Xiong, R. Ratan (2009, in press). As real as real? Macroeconomic behavior in a large-scale virtual world. New Media and Society.
[7] D. Chan, Negotiating intra-Asian games networks: on cultural proximity, East Asian games design, and Chinese farmers, FibreCulture, vol. 8, 2006.
[8] H. Chen, R. V. Hauck, H. Atabakhsh, H. Gupta, C. Boarmana, J Schroeder, L. Ridgeway, COPLINK*: Information and Knowledge Management for Law Enforcement. Photonics East Conference, SPIE, Technologies for Law Enforcement; Boston Nov. 5-8, 2000.
[9] H. Chen, W. Chung, J. J. Xu, G. Wang, Y. Qin, and M. Chau, Crime Data Mining: A General Framework and Some Examples, Computers & Security, vol. 37, no. 4, 2004, pp. 50-56.
[10] R. Davis, Welcome to the new gold mines, The Guardian, 2009.
[11] J. Dibbell, Play Money: Or, How I Quit My Day Job and Made Millions Trading Virtual Loot, Basic Books, 2006.
[12] J. Dibbell, The Life of a Chinese gold farmer, Book The Life of a Chinese gold farmer, Series The Life of a Chinese gold farmer, ed., Editor ed. 2007.
[13] D. Geer, The Physics of Digital Law: Searching for Counterintuitive Analogies, Cybercrime: Digital Cops in a Networked Environment, J. M. Balkin, G. Grimmelmann, E. Katz, N. Kozlovski, S. Wagman, and T. Karzky eds., New York University Press, 2007.
[14] Grimmelmann, J. (2006). Virtual Power Politics. The State of Play: Law, Games, and Virtual Worlds. J. M. Balkin and B. S. Noveck. New York, N.Y. University Press.
[15] Heeks, Richard. Analysis Current Analysis and Future Research Agenda on “gold farming”: Real-World Production in Developing Countries for the Virtual Economies of Online Games Development Informatics Group IDPM, SED, University of Manchester, UK—2008.
[16] B. Howell, Real World Problems of Virtual Crime, Cybercrime: Digital Cops in a Networked Environment, J. M. Balkin, G. Grimmelmann, E. Katz, M. Kozlovski, S. Wagman, and T. Karzky eds., New York University Press, 2007.
[17] J.-S. Huhh, Culture and Business of PC Bangs in Korea, Games and Culture, vol. 3, no. 1, 2008, pp. 26.
[18] Hunter, D. The early history of real money trades, TerraNova, 13 Jan. 2006 http://terranova.blogs.com/terra nova/2006/01/the early histo.html.
[19] A. E. Jankowich, Property and Democracy in Virtual Worlds, Boston University Journal of Science and Technology, vol. 11, no. 2, 2005.
[20] G. Jin, Chinese Gold Farmers in the Game World, Consumers, Commodities, & Consumption, vol. 7, no. 2, 2006.
[21] G. Lastowka, ID theft, RMT & Lineage, Terra Nova 2006; http://terranova.blogs.com/terra nova/2006/07/id theft rmt nc.html.
[22] Aleksandar Lazarevic, Levent Ertz, Vipin Kumar, Aysel Ozgur, Jaideep Srivastava A Comparative Study of Anomaly Detection Schemes in Network Intrusion Detection. SDM 2003.
[23] J. Lee, Wage slaves, Book Wage slaves, Series Wage slaves July/August, ed., Editor ed. eds., 2005, pp. 20-23.
[24] V. Lehdonvirta, Virtual economics: applying economics to the study of game worlds, Virtual economics: applying economics to the study of game worlds, 2005.
[25] T. Lehtiniemi, How big is the RMT market anyway, Virtual Economy Research Network, no. Mar. 2, 2007.
[26] T. M. Malaby, Anthropology and Play: The Contours of Playful Experience, SSRN, 2008.
[27] S. Schiesel, Virtual Achievement for Hire: It's Only Wrong if You Get Caught, Book Virtual Achievement for Hire: It's Only Wrong if You Get Caught, Series Virtual Achievement for Hire: It's Only Wrong if You Get Caught, Dec. 9, 2005.
[28] T. Taylor, Play between worlds: Exploring online game culture, MIT Press, 2006.
[29] K. Taipale, How Technology, Security, and Privacy Can Coexist in the Digital Age, Cybercrime: Digital Cops in a Networked Environment, J. M. Balkin, G. Grimmelmann, E. Katz, N. Kozlovski, S. Wagman, and T. Karzky eds., New York University Press, 2007.
[30] Tyren, World of Warcraft Accounts Closed Worldwide, 2006; http://forums.worldofwarcraft.com/thread.html?topicId=59377507.
[31] van Rijsbergen, 1979 van Rijsbergen, C. J. (1979). Information Retrieval. Butterworths, London.
[32] White, P. (2008). MMOG Data: Charts. Gloucester, United Kingdom. http://mmogdata.voig.com/
[33] Brian Wilcox Sony Online Entertainment Personal Communication.
[34] Ian H. Witten and Eibe Frank (2005) Data Mining: Practical machine learning tools and techniques, 2nd Edition, Morgan Kaufmann, San Francisco, 2005.
[35] N. Yee, Buying gold, Daedalus Project2005; http://www.nickyee.com/daedalus/archives/pdf/3-5.pdf.
[36] N. Yee, The labor of fun: how video games blur the boundaries of work and play, Games and Culture, vol. 1, no. 1, 2006, pp. 68-71.

Unless otherwise indicated, the automatic gold farmer detection systems and methods that have been discussed herein are implemented with a computer system configured to perform the functions that have been described herein for the component. Each computer system includes one or more processors, memory devices (e.g., random access memories (RAMs), read-only memories (ROMs), and/or programmable read only memories (PROMS)), tangible storage devices (e.g., hard disk drives, CD/DVD drives, and/or flash memories), system buses, video processing components, network communication components, input/output ports, and/or user interface devices (e.g., keyboards, pointing devices, displays, microphones, sound reproduction systems, and/or touch screens).

Each computer system for the automatic gold farmer detection system and method may include one or more computers at the same or different locations. When at different locations, the computers may be configured to communicate with one another through a wired and/or wireless network communication system.

Each computer system may include software (e.g., one or more operating systems, device drivers, application programs, and/or communication programs). When software is included, the software includes programming instructions and may include associated data and libraries. When included, the programming instructions are configured to implement one or more algorithms that implement one more of the functions of the computer system, as recited herein. Each function that is performed by an algorithm also constitutes a description of the algorithm. The software may be stored on one or more non-transitory, tangible storage devices, such as one or more hard disk drives, CDs, DVDs, and/or flash memories. The software may be in source code and/or object code format. Associated data may be stored in any type of volatile and/or non-volatile memory.

The components, steps, features, objects, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits and advantages. These also include embodiments in which the components and/or steps are arranged and/or ordered differently.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases in a claim mean that the claim is not intended to and should not be interpreted to be limited to these corresponding structures, materials, or acts or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as first and second and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by “a” or “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended embracement of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. A system for automatically identifying gold farmers in a massively multiplayer role playing game (MMOG) comprising:
an input module configured to receive data containing information about players in the MMOG;
an analysis module configured to analyze the data for the purpose of identifying players that appear likely to be gold farmers; and
a reporting module configured to report the results of the analysis.
